(19) United States
(12) Patent Application Publication
(10) Pub. No.: US 2002/0197359 A1
(43) Pub. Date: Dec. 26, 2002

(54) Package for instant food and method of manufacturing the same

(76) Inventor: Dong-hyun Kim, Gyunggi-do (KR)

Correspondence Address: LADAS & PARRY, 224 SOUTH MICHIGAN AVENUE, SUITE 1200, CHICAGO, IL, 60604, US

(21) Appl. No.: 10/158,328

(22) Filed: May 30, 2002

(30) Foreign Application Priority Data
Jun. 22, 2001 (KR) 2001-35942
Aug. 3, 2001 (KR) 2001-46889

(51) Int. Cl. A23B 4/00

(52) U.S. Cl. 426/112

(57) ABSTRACT

A package for instant food and a method of manufacturing the same are disclosed. The package for instant food comprises a main-package for packing instant food therein in a sealed state, and a sub-package formed integrally with the main-package, defining a separate sealed space at a side of the main-package, the sub-package for holding a wet washcloth in the sealed space. According to the method of manufacturing the package for instant food, a user is allowed to wipe his/her fingers with the wet washcloths right after eating the instant food, it can satisfy the user's needs for cleanliness and solve sanitary problem.

### BACKGROUND OF THE INVENTION

1. Field of the Invention

The present invention relates to a package for instant food and a method of manufacturing the same, and more particularly, to a package for instant food having a wet washcloth and a method of manufacturing the same.

2. Description of the Prior Art

Generally, instant food such as biscuits or snacks is distributed in a sealed package. In order to eat the instant food, a person has to use his/her fingers. Accordingly, the fingers get dirty with seasoning material added to the instant food or crumbs. The person feels more unpleasant when the food is oily and has a difficulty in removing the seasoning material from his/her fingers.

Accordingly, after eating the instant food, the person usually cleans his/her hands with a paper tissue or water, to get rid of the unpleasant feeling.

However, when it comes to children who have a weaker consciousness on the hygiene than adults, as they rather wipe the fingers on their clothes, suck the fingers or leave the dirty fingers as they are. Accordingly, there occurs an unsanitary condition that results in generating disease-causing germs.

### SUMMARY OF THE INVENTION

The present invention has been developed in order to solve the above problems of the related art. Accordingly, it is an object of the present invention to provide a package for instant food and a method of manufacturing the same, which is capable of solving an sanitary problem by allowing person to easily remove foreign material covering his/her fingers when eating the instant food with fingers.

In order to achieve the above object, a package for instant food according to the present invention, comprises: a main-package for packing instant food therein in a sealed state; and a sub-package formed integrally with the main-package, defining a separate sealed space at a side of the main-package, the sub-package for holding a wet washcloth in the sealed space.

Preferably, the sub-package has opening guide grooves formed on a surface thereof, the opening guide grooves formed along the centerline of the sub-package, for allowing an easy opening of the sub-package.

Also, the main-package has serrate perforations formed along a side thereof, for allowing an easy opening of the main-package, and a side edge of the sub-package corresponds to the serrate perforations.

The sub-package is made of a material identical to that of the main-package.

Also, the sub-package is extended from one of both sealed sides of the main-package.

Meanwhile, the sub-package is disposed either on an inner surface or an outer surface of the main-package.

Also, in order to achieve the above object, a method of manufacturing a package for instant food according to the present invention, comprises the steps of: forming a partitioning line by a thermocompressing bonding across a cylindrical member and distanced apart from an end of the cylindrical member, the cylindrical member having a predetermined length and two open ends, the partitioning line for partitioning the cylindrical member into two separate spaces; putting instant food into a first space formed from the end of the cylindrical member to the partitioning line, and sealing the end by the thermocompression bonding; and putting a wet washcloth into a second space formed from the other end opposing to the end of the cylindrical member to the partitioning line, and sealing the other end by the thermocompression bonding.

A method of manufacturing a package for instant food according to another aspect of the present invention, comprises the steps of: putting instant food into a main-package, which has a closed end and the other open end, through the other open end, and sealing the other open end by a thermocompression bonding; and overlapping the other open end of the main-package with an end of a sub-package holding a wet washcloth therein, and connecting the overlapping portions of the sub-package and the main-package by the thermocompression bonding.

### BRIEF DESCRIPTION OF THE DRAWINGS

The above object and characteristic of the present invention will be more apparent by describing preferred embodiments of the present invention in greater detail with reference to the accompanying drawings, in which:

FIG. 1 is a perspective view showing an exterior of a package for instant food according to the first embodiment of the present invention;

FIG. 2 is a partially-cut perspective view showing the package of FIG. 1 in use;

FIG. 3 is a perspective view showing an exterior of a package for instant food according to the second embodiment of the present invention;

FIG. 4 is a perspective view showing an exterior of a package for instant food according to the third embodiment of the present invention;

FIGS. 5A and 5C are plan views showing a package in a manufacturing process; and

FIGS. 6A and 6B are plan views showing a package in another manufacturing process.

### DETAILED DESCRIPTION OF THE PREFERRED EMBODIMENT

Hereinafter, a package for instant food according to the present invention will be described in greater detail with reference to the accompanying drawings.

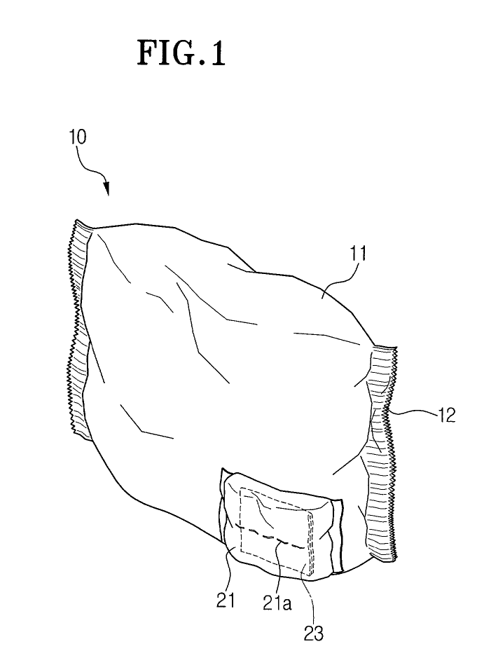

FIG. 1 is a perspective view showing an exterior of a package for instant food in accordance with the first embodiment of the present invention.

Referring to FIG. 1, a package 10 for instant food comprises a main-package 11 for packing instant food in a sealed state and a sub-package 21 disposed on a side of the main-package 11.

The main-package 11 contains the instant food (not shown) therein. The main-package 11 has serrate perforations 12 formed along a sealed side or along one and the other sealed sides of the main-package 11, the serrate perforations 12 for allowing a user to easily tear-open the main-package 11.

The sub-package 21 is positioned on the main-package 21, defining a separate space from the main-package 11. The sub-package 21 holds a wet washcloth 23 in the separate space.

The wet washcloth 23 is a tissue paper that holds a toxic-free detergent therein for easy cleaning.

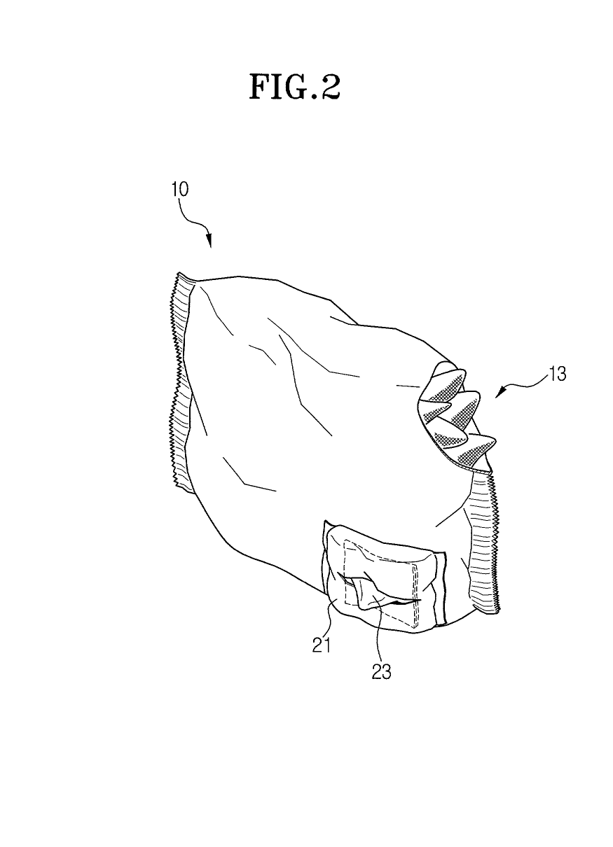

Preferably, the sub-package 21 has opening guide grooves 21a formed on an exposure surface of the sub-package 21, for allowing easy opening of the sub-package 21. The guide grooves 21a are formed along the centerline of the sub-package 21. Accordingly, as a user pulls both sides of the sub-package 21 in an opposite direction with respect to the line of the opening guide grooves 21a, he/she could easily tear-open the sub-package 21 as shown in FIG. 2 and use the wet washcloth 23. The reference numeral 13 indicates an opening of the main-package 11 opened by the user.

Preferably, the main-package 11 and the sub-package 21 are both made of synthetic resin material such as vinyl.

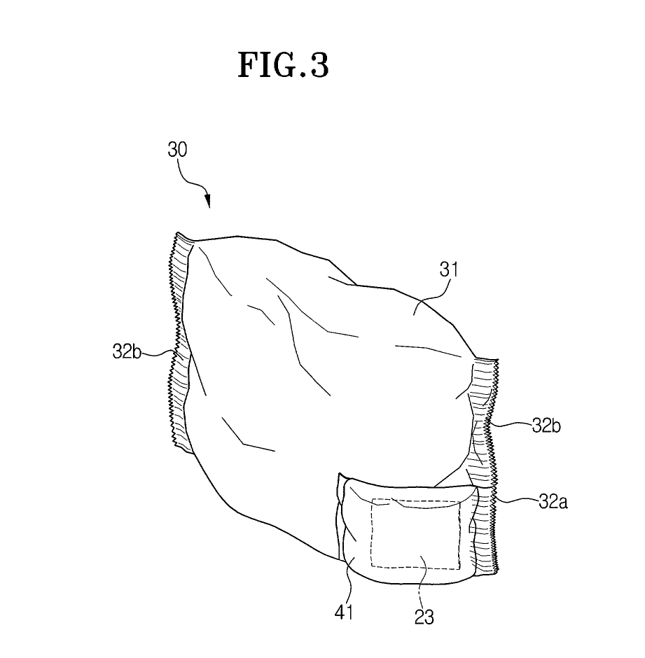

FIG. 3 shows the second embodiment of the present invention.

Referring to FIG. 3, a package 30 for instant food comprises a main-package 31 and a sub-package 41. The main-package 31 packs the instant food in a sealed state, and has serrate perforations 12 formed along a sealed side of the main-package 31, for allowing a user to easily tear-open the main-package 31. An edge of the sub-package 41 corresponds the serrate perforations 12.

In this embodiment, in order to eat the instant food, the user opens the main-package 31 by tear-opening second serrate perforations 32b, not corresponding to the edge of the sub-package 41. On the other hand, in order to use a wet washcloth 23, the user opens the sub-package 41 by tear-opening first serrate perforations 32a which commonly belong to the sub-package 41 and the main-package 31.

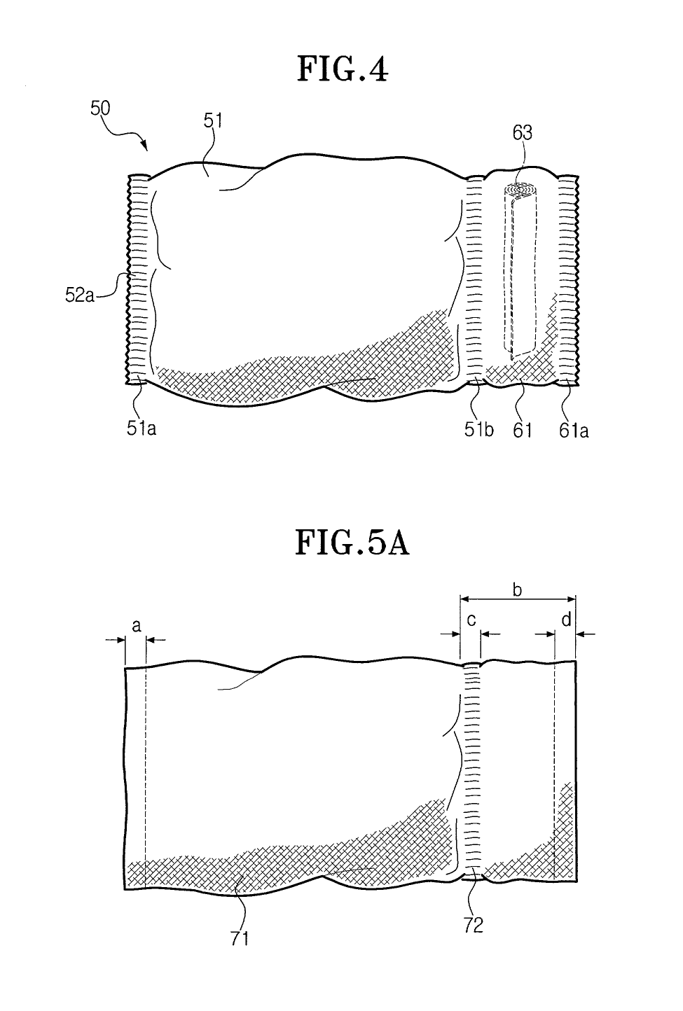

FIG. 4 shows a package for instant food in accordance with the third embodiment of the present invention.

Referring to FIG. 4, a package 50 for instant food comprises a main-package 51 for packing instant food in a sealed state and a sub-package 61 extended from one of first and second sealed sides 51a and 51b of the main-package 51.

In this embodiment, in order to eat the instant food, a user opens the main-package 51 by tear-opening serrate perforations 52a of the first sealed side 51a of the main-package 51, and in order to use a wet washcloth 63, the user opens the sub-package 61 by tear-opening a sealed side 61a of the sub-package 61. Here, the second sealed side 51b is a vertical partitioning line.

The package for instant food described according to the above embodiments is manufactured by various methods.

For example, the sub-packages 21, 41, 61 holding the wet washcloths 23, 63 therein can be attached to a position of the main-packages 11, 31, 51 by a thermocompression bonding.

Also, as shown in FIGS. 1 through 3, the packages 10, 30 can be manufactured in a manner that the sub-package 21, 41 are disposed on the main-packages 11, 31 to partially share external surfaces of the main-packages 11, 31, with one end of each being opened, and the wet wash cloth 23 is put into the sub-packages 21, 41 through the open ends of the sub-package 21, 41, and the open ends are sealed by the thermocompression bonding. The method has an advantage of reducing a size of the packages 10, 30 to the extent that corresponds to the size of the sub-packages 21, 41.

After instant food is put into the main-package 11, 31 through the open sides, the main-packages 11, 31 are sealed by the thermocompression bonding. The process of sealing the main-packages 11, 31 can be performed after or before the sub-package 11, 31 are sealed.

Alternatively, the main-packages 11, 31 and the sub-packages 21, 41 are manufactured separately, hold the contents i.e. instant food and a wet washcloth, respectively, and then connected to each other by an adhesive or an adhesive tape.

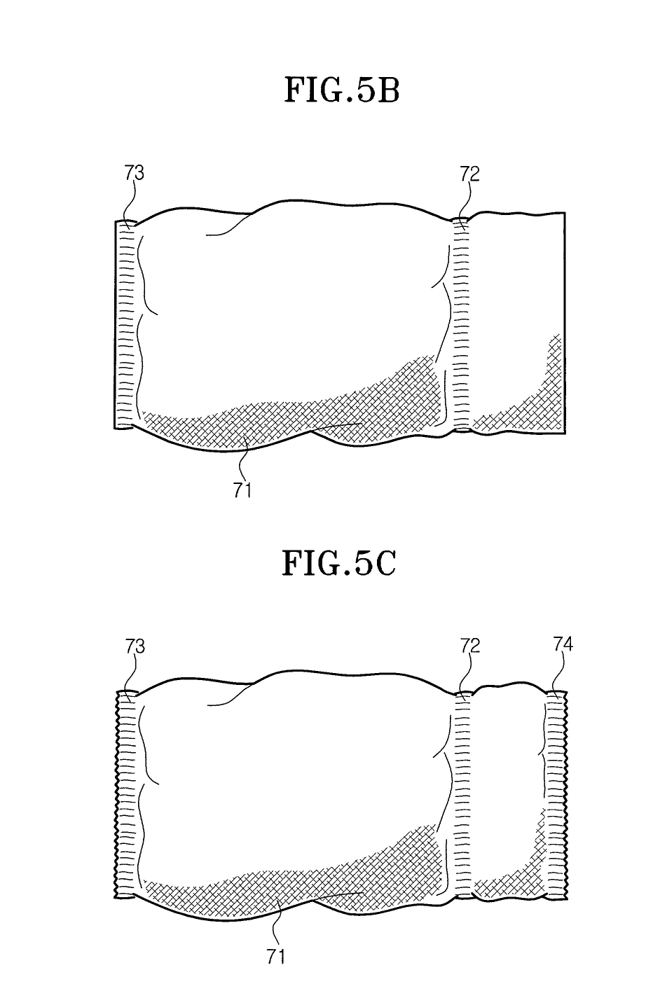

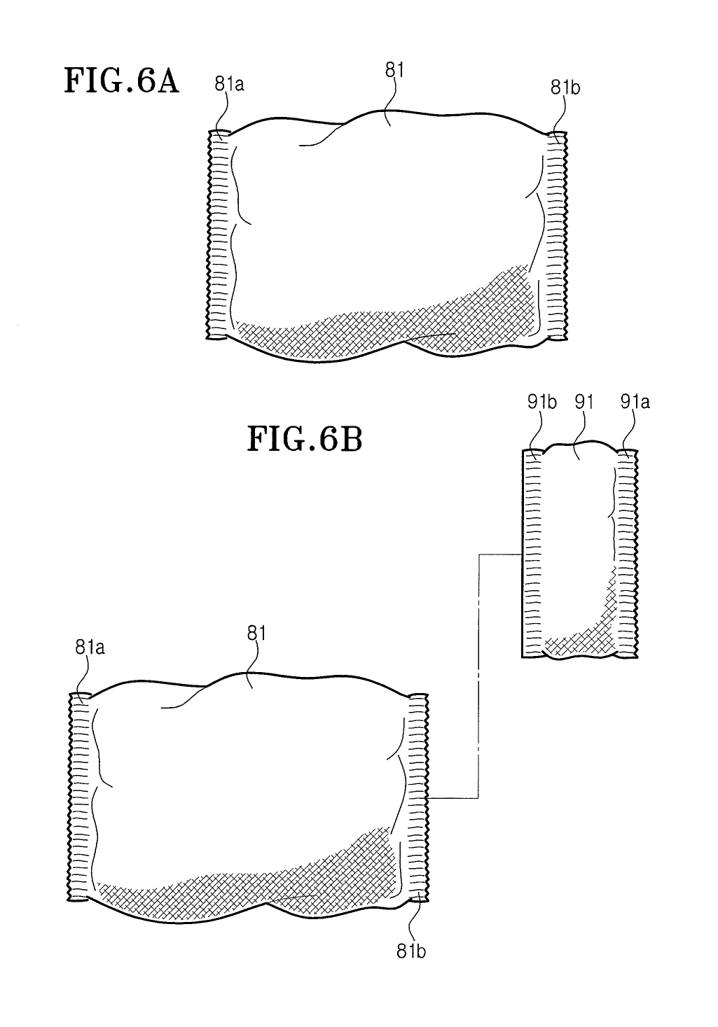

Hereinafter, methods of manufacturing the package for instant food shown in FIG. 4 will be described with reference to FIGS. 5A through 6B.

According to the first method, a partitioning line is formed with a predetermined width by a thermocompression bonding across a cylindrical member having two open ends, apart from an end of the cylindrical member by a predetermined distance, the partitioning line for partitioning the cylindrical member into two separate spaces. In other words, as shown in FIG. 5A, a package is made in a manner that a partitioning line 72 is formed with a predetermined width “c” by a thermocompressing bonding across cylindrical member 71 and apart from an end of the cylindrical member 71 by a distance “b”, Accordingly, the cylindrical member 71 is partitioned into two separate spaces by the partitioning line 72. Here, “a” portion and a “d” portion of the cylindrical member 71 are respectively used for a first sealed portion of a main-package and a sealed portion of a sub-package.

Next, instant food is put into a first space formed by the partitioning line 72 and then the “a” portion is sealed by a thermocompression bonding to be a first sealed portion 73 as shown in FIG. 5B. The wet washcloth 63 is put into a second space formed from the other end of the cylindrical member 71 to the partitioning line 72 and then the “b” portion is sealed by the thermocompression bonding to be a second sealed portion 74 as shown in FIG. 5C.

Next, by partially perforating the first and second sealed portions 73 and 74 of the package in a serrate fashion, the manufacturing of the package shown in FIG. 4 is completed.

According to the second method, a first sealed portion 73 is firstly formed at an end of cylindrical member 71, instant food is put through an opening opposing to the first sealed portion 73, a partitioning line 73 is formed by a thermocompression bonding, a wet washcloth 63 is input, and the other end of the cylindrical member 71 is sealed.

According to the third method, a second sealed portion 74 is firstly formed at an end of cylindrical member 71, a wet washcloth 63 is put through an opening opposing to the second sealed portion 74, a partitioning line 73 is formed by a thermocompression bonding, instant food is put, and the other end of the cylindrical member 71 is sealed.

According to the fourth method, as shown in FIG. 6A, instant food is packed in a main-package 81 in a sealed state, and as shown in FIG. 6B, a wet washcloth 63 is placed in a sub-package 91 in a sealed state. A sealed portion 81b of the main-package 81 and a sealed portion 91b of the sub-package 91 are overlapped with each other and are connected to each other by a thermocompression bonding.

According to the fifth method, an overlapping portion of a main-package 81 and/or a sub-package 91 remains in an opened state while the rest portion of the main-package 81 and/or the sub-package 91 is sealed. Instant food and/or a wet washcloth are put into the main-package 81 and/or the sub-package 91, and the opened overlapping portions of the main-package 81 and the sub-package 91 are connected to each other by a thermocompression boning.

Although the above embodiments depicted the sub-packages 21, 41 are disposed on an exterior of the main-packages 11, 31, this should not be considered as limiting. For example, the sub-packages 21, 41 can be disposed inside the main-packages 11, 31.

Since the package for instant food according to the present invention as described above allows a user to wipe his/her fingers with the wet washcloths 23, 63 right after eating the instant food, it can satisfy the user's needs for cleanliness and solve sanitary problem.

What is claimed is:

1. A package for instant food comprising:
a main-package for packing instant food therein in a sealed state; and
a sub-package formed integrally with the main-package, defining a separate sealed space at a side of the main-package, the sub-package for holding a wet washcloth in the sealed space.

2. The package for instant food of claim 1, wherein the sub-package has opening guide grooves formed on a surface thereof, the opening guide grooves formed along the centerline of the sub-package, for allowing an easy opening of the sub-package.

3. The package for instant food of claim 1, wherein the main-package has serrate perforations formed along a side thereof, for allowing an easy opening of the main-package, and a side edge of the sub-package corresponds to the serrate perforations.

4. The package for instant food of claim 1, wherein the sub-package is made of a material identical to that of the main-package.

5. The package for instant food of claim 1, wherein the sub-package is extended from one of both sealed sides of the main-package.

6. The package for instant food of claim 1, wherein the sub-package is disposed either on an inner surface or an outer surface of the main-package.

7. A method of manufacturing a package for instant food comprising the steps of:
forming a partitioning line by a thermocompressing bonding across a cylindrical member and distanced apart from an end of the cylindrical member, the cylindrical member having a predetermined length and two open ends, the partitioning line for partitioning the cylindrical member into two separate spaces;
putting instant food into a first space formed from the end of the cylindrical member to the partitioning line, and sealing the end by the thermocompression bonding; and
putting a wet washcloth into a second space formed from the other end opposing to the end of the cylindrical member to the partitioning line, and sealing the other end by the thermocompression bonding.

8. A method of manufacturing a package for instant food, comprising the steps of:
putting instant food into a main-package, which has a closed end and the other open end, through the other open end, and sealing the other open end by a thermocompression bonding; and
overlapping the other open end of the main-package with an end of a sub-package holding a wet washcloth therein, and connecting the overlapping portions of the sub-package and the main-package by the thermocompression bonding.
